(19) United States
(12) Patent Application Publication
(10) Pub. No.: US 2026/0328467 A1
(43) Pub. Date: Oct. 22, 2026

(54) REFRIGERATOR

(71) Applicant: SAMSUNG ELECTRONICS CO., LTD., Suwon-si (KR)

(72) Inventors: Seungjin LEE, Suwon-si (KR); Dongpil SEO, Suwon-si (KR); Taehyun SUNG, Suwon-si (KR); Sejin YUN, Suwon-si (KR)

(73) Assignee: SAMSUNG ELECTRONICS CO., LTD., Suwon-si (KR)

(21) Appl. No.: 19/707,896

(22) Filed: Jun. 15, 2026

Related U.S. Application Data
(63) Continuation of application No. PCT/KR2024/020918, filed on Dec. 23, 2024.

(30) Foreign Application Priority Data
Feb. 22, 2024 (KR) 10-2024-0026075
May 10, 2024 (KR) 10-2024-0062097

(51) Int. Cl. F25D 17/06; F25D 17/08

(52) U.S. Cl. CPC F25D 17/065; F25D 17/08; F25D 2300/00; F25D 2323/0024

(57) ABSTRACT

A refrigerator including a main body, a thermoelectric element, a heat sink, a heat dissipation fan, a heat dissipation duct, including an outside air inlet and an outside air outlet, to guide air flowing by the heat dissipation fan to exchange heat with the heat sink, a top cover including a filter receiving space, and a dust filter coupleable in and decoupleable from the filter receiving space. The dust filter includes a filter member configured to filter dust from the air and a filter frame configured to support the filter member. The filter frame includes a rear rib protruding upwardly from the filter frame to prevent the dust filtered by the filter member from entering the heat dissipation duct including while the dust filter is decoupled from the filter receiving space.

### CROSS-REFERENCE TO RELATED APPLICATION

This application is a continuation application, under 35 U.S.C. § 111(a), of international application No. PCT/KR2024/020918, filed Dec. 23, 2024, which claims priority under 35 U.S.C. § 119 to Korean Patent Application No. 10-2024-0026075, filed Feb. 22, 2024 and Korean Patent Application No. 10-2024-0062097, filed May 10, 2024, the disclosures of which are incorporated herein by reference in their entireties.

### TECHNICAL FIELD

The disclosure relates to a refrigerator having an improved structure.

### BACKGROUND ART

A refrigerator is an appliance for keeping food fresh, including a main body having a storage compartment, a cold air supply device for supplying cold air to the storage compartment.

The cold air supply device of the refrigerator may utilize a thermoelectric cooling device that generates heating and cooling via the Peltier effect. The thermoelectric cooling device may include a thermoelectric element. The thermoelectric element has a heat generating portion formed on one side and a heat absorbing portion formed on the opposite side, and when a current is applied to the thermoelectric element, heat generation may occur at the heat generating portion and heat absorption may occur at the heat absorbing portion.

The thermoelectric cooling device may include a heat dissipating sink, a cooling sink, a heat dissipation fan, a cooling fan, a heat dissipation duct, and a cooling duct to increase the efficiency of cooling the storage compartment through the thermoelectric cooling device.

### DISCLOSURE

### Technical Problem

An aspect of the present disclosure provides a refrigerator having a dust filter provided to filter air drawn into a heat dissipation duct.

An aspect of the present disclosure provides a refrigerator capable of preventing dust filtered by a dust filter from entering a heat dissipation duct when the dust filter is separated.

Technical tasks to be achieved in this document are not limited to the technical tasks mentioned above, and other technical tasks not mentioned will be clearly understood by those skilled in the art from the description below.

### Technical Solution

A refrigerator according to an embodiment of the present disclosure includes a main body, a thermoelectric element to be provided on an upper wall of the main body and having a heat generating portion and a heat absorbing portion, a heat sink in contact with the heat generating portion, a heat dissipation fan configured to generate air flow, a heat dissipation duct, including an outside air inlet and an outside air outlet, configured to be coupled to the upper wall of the main body such that while the heat dissipation duct is coupled to the upper wall of the main body, air guided by the heat dissipation fan flows through the heat dissipation duct to exchange heat with the heat sink, a top cover, including a filter receiving space, to be provided in a position corresponding to the outside air inlet, and a dust filter coupleable in and decoupleable from the filter receiving space. The dust filter includes a filter member configured to filter out dust from the air and a filter frame configured to support the filter member. The filter frame includes a rear rib protruding upwardly from the filter frame to prevent the dust filtered by the filter member from entering the heat dissipation duct including based on the dust filter being decoupled from the filter receiving space.

A refrigerator according to an embodiment of the present disclosure includes a main body, a thermoelectric element to be provided on an upper wall of the main body and having a heat generating portion and a heat absorbing portion, a heat sink configured to contact the heat generating portion, a heat dissipation fan configured to cause air to flow, a heat dissipation duct, having an outside air inlet and an outside air outlet, configured to be coupled to the upper wall of the main body to guide air flowing by the heat dissipation fan to exchange heat with the heat sink, a top cover, including a filter receiving space, to be provided in a position corresponding to a position of the outside air inlet and an air inlet portion provided on one side of the filter receiving space, and a dust filter coupleable in and decoupleable from the filter receiving space of the top cover. The dust filter includes a filter member configured to filter out dust from the air and a filter frame configured to support the filter member. The filter frame includes a rear rib protruding from a rear end of the filter frame toward the air inlet portion including based on the dust filter being coupled in the filter receiving space.

### DESCRIPTION OF DRAWINGS

FIG. 1 is a perspective view illustrating a refrigerator according to an embodiment.

FIG. 2 is a perspective view illustrating a state in which doors of a refrigerator according to an embodiment are opened.

FIG. 3 is a view of an upper portion of a storage compartment of a refrigerator according to an embodiment, viewed from below.

FIG. 4 is a side cross-sectional view schematically illustrating a refrigerator according to an embodiment.

FIG. 5 is a cross-sectional view taken along line I-I indicated in FIG. 2 according to an embodiment.

FIG. 6 is a view illustrating a top cover, a dust filter, and a heat dissipation duct separated from a main body, according to an embodiment.

FIG. 7 is a view illustrating a heat dissipation duct cover, a heat dissipation duct body, and a thermoelectric module separated from each other, according to an embodiment.

FIG. 8 is a perspective view illustrating a lower surface of a top cover according to an embodiment.

FIG. 9 is a view illustrating a flow of air by a heat dissipation fan, a dissipating duct, and a top cover, according to an embodiment.

FIG. 10 is a perspective view illustrating a dust filter according to an embodiment.

FIG. 11 is a perspective view illustrating a lower surface of the dust filter shown in FIG. 10 according to an embodiment.

FIG. 12 is a perspective view illustrating a state in which the dust filter is mounted on the top cover according to an embodiment.

FIG. 13 is a perspective view illustrating a state in which the dust filter is separated from the top cover shown in FIG. 12 according to an embodiment.

FIG. 14 is a cross-sectional view taken along line II-II indicated in FIG. 12 according to an embodiment.

FIG. 15 is an enlarged view of portion A indicated in FIG. 14 according to an embodiment.

FIG. 16 is a cross-sectional view taken along line III-III of FIG. 12 according to an embodiment.

FIG. 17 is an enlarged view of portion B indicated in FIG. 16 according to an embodiment.

FIG. 18 is a perspective view illustrating a dust filter according to an embodiment.

FIG. 19 is a perspective view illustrating a dust filter according to an embodiment.

FIG. 20 is an enlarged view illustrating a state in which a rear rib of a filter frame and a barrier wall of a top cover are in contact when the dust filter shown in FIG. 19 is mounted on the top cover, according to an embodiment.

### MODES OF THE INVENTION

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

Further, as used in the disclosure, the terms “front”, “rear”, “top”, “bottom”, “side”, “left”, “right”, “upper”, “lower”, and the like are defined with reference to the drawings, and are not intended to limit the shape and position of any element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

A refrigerator according to an embodiment of the disclosure may include a main body.

The “main body” may include an inner case, an outer case positioned outside the inner case, and an insulation provided between the inner case and the outer case.

The “inner case” may include a case, a plate, a panel, or a liner forming a storage compartment (also referred to as a storage room). The inner case may be formed as one body, or may be formed by assembling a plurality of plates together. The “outer case” may form an appearance of the main body, and be coupled to an outer side of the inner case such that the insulation is positioned between the inner case and the outer case.

The “insulation” may insulate an inside of the storage compartment from an outside of the storage compartment to maintain inside temperature of the storage compartment at appropriate temperature without being influenced by an external environment of the storage compartment. According to an embodiment of the disclosure, the insulation may include a foaming insulation. The foaming insulation may be molded by fixing the inner case and the outer case with jigs, etc. and then injecting and foaming urethane foam as a mixture of polyurethane and a foaming agent between the inner case and the outer case.

According to an embodiment of the disclosure, the insulation may include a vacuum insulation in addition to a foaming insulation, or may be configured only with a vacuum insulation instead of a forming insulation. The vacuum insulation may include a core material and a cladding material accommodating the core material and sealing the inside with vacuum or pressure close to vacuum. However, the insulation is not limited to the above-mentioned foaming insulation or vacuum insulation, and may include various materials capable of being used for insulation.

The “storage compartment” may include a space defined by the inner case. The storage compartment may further include the inner case defining the space corresponding to the storage compartment. The storage compartment may store a variety of items, such as food, medicines, cosmetics, and the like, and the storage compartment may be configured to be open on at least one side for insertion and removal of the items.

The refrigerator may include one or more storage compartments. In a case in which two or more storage compartments are formed in the refrigerator, the respective storage compartments may have different purposes of use, and may be maintained at different temperatures. To this end, the respective storage compartments may be partitioned by a partition wall including an insulation.

The storage compartment may be maintained within an appropriate temperature range according to a purpose of use, and may include a “refrigerating compartment”, a “freezing compartment”, and a “variable temperature compartment” according to purposes of use and/or temperature ranges. The refrigerating compartment may be maintained at an appropriate temperature to keep food refrigerating, and the freezing compartment may be maintained at an appropriate temperature to keep food frozen. The “refrigerating” may be keeping food cold without freezing the food, and for example, the refrigerating compartment may be maintained within a range of 0 degrees Celsius to 7 degrees Celsius. The “freezing” may be freezing food or keeping food frozen, and for example, the freezing compartment may be maintained within a range of −20 degrees Celsius to −1 degrees Celsius. The variable temperature compartment may be used as either a refrigerating compartment or a freezing compartment according to or regardless of a user's selection.

The storage compartment may also be referred to by various terms, such as “vegetable compartment”, “freshness compartment”, “cooling compartment”, and “ice-making compartment”, in addition to “refrigerating compartment”, “freezing compartment”, and “variable temperature compartment”, and the terms, such as “refrigerating compartment”, “freezing compartment”, “variable temperature compartment”, etc., as used below are to be understood as representing storage compartments having the corresponding purposes of use and the corresponding temperature ranges.

The refrigerator according to an embodiment of the disclosure may include at least one door configured to open or close the open side of the storage compartment. The respective doors may be provided to open or close one or more storage compartments, or a single door may be provided to open or close a plurality of storage compartments. The door may be rotatably or slidably mounted to the front of the main body.

The “door” may seal the storage compartment in a closed state. The door, like the main body, may include an insulation to insulate the storage compartment in a closed state.

According to an embodiment, the door may include an outer door plate forming the front surface of the door, an inner door plate forming the rear surface of the door and facing the storage compartment, an upper cap, a lower cap, and a door insulation provided therein.

A gasket may be provided on the edge of the inner door plate to seal the storage compartment by coming into close contact with the front surface of the main body when the door is closed. The inner door plate may include a dyke that protrudes rearward to allow a door basket for storing items to be fitted.

According to an embodiment, the door may include a door body and a front panel that is detachably coupled to the front of the door body and forming the front surface of the door. The door body may include an outer door plate forming the front surface of the door body, an inner door plate forming the rear surface of the door body and facing the storage compartment, an upper cap, a lower cap, and a door insulator provided therein.

The refrigerator may be classified as French Door Type, Side-by-side Type, Bottom Mounted Freezer (BMF), Top Mounted Freezer (TMF), or Single Door Refrigerator according to the arrangement of the doors and the storage compartments.

The refrigerator according to an embodiment of the disclosure may include a cold air supply device for supplying cold air to the storage compartment.

The “cold air supply device” may include a machine, an apparatus, an electronic device, and/or a combination system thereof, capable of generating cold air and guiding the cold air to cool the storage compartment.

According to an embodiment of the disclosure, the cold air supply device may generate cold air through a cooling cycle including compression, condensation, expansion, and evaporation processes of refrigerants. To this end, the cold air supply device may include a refrigeration cycle device having a compressor, a condenser, an expander, and an evaporator to drive the refrigeration cycle. According to an embodiment of the disclosure, the cold air supply device may include a semiconductor, such as a thermoelectric element. The thermoelectric element may cool the storage compartment by heating and cooling actions through the Peltier effect.

The refrigerator according to an embodiment of the disclosure may include a machine compartment in which at least some components belonging to the cold air supply device are installed.

The “machine compartment” may be partitioned and insulated from the storage compartment to prevent heat generated by the components installed in the machine compartment from being transferred to the storage compartment. To dissipate heat from the components installed in the machine compartment, the machine compartment may communicate with outside of the main body.

The refrigerator according to an embodiment of the disclosure may include a dispenser provided on the door to provide water and/or ice. The dispenser may be provided on the door to allow access by the user without opening the door.

The refrigerator according to an embodiment of the disclosure may include an ice-making device that produces ice. The ice-making device may include an ice-making tray that stores water, an ice-moving device that separates ice from the ice-making tray, and an ice-bucket that stores ice produced in the ice-making tray.

The refrigerator according to an embodiment of the disclosure may include a controller for controlling the refrigerator.

The “controller” may include a memory for storing and/or recording data and/or programs for controlling the refrigerator, and a processor for outputting control signals for controlling the cold air supply device, etc. in accordance with the programs and/or data stored in the memory.

The memory may store or record various information, data, instructions, programs, and the like necessary for operation of the refrigerator. The memory may store temporary data generated while generating control signals for controlling components included in the refrigerator. The memory may include at least one of a volatile memory or a non-volatile memory, or a combination thereof.

The processor may control the overall operation of the refrigerator. The processor may control the components of the refrigerator by executing programs stored in memory. The processor may include a separate neural processing unit (NPU) that performs an artificial intelligence (AI) model operation. In addition, the processor may include a central processing unit (CPU), a graphics processor (GPU), and the like. The processor may generate a control signal to control the operation of the cold air supply device. For example, the processor may receive temperature information of the storage compartment from a temperature sensor and generate a cooling control signal to control an operation of the cold air supply device based on the temperature information of the storage compartment.

Furthermore, the processor may process a user input of a user interface and control an operation of the user interface in accordance with the programs and/or data memorized/stored in the memory. The user interface may be provided with an input interface and an output interface. The processor may receive the user input from the user interface. In addition, the processor may transmit a display control signal and image data for displaying an image on the user interface to the user interface in response to the user input.

The processor and memory may be provided integrally or may be provided separately. The processor may include one or more processors. For example, the processor may include a main processor and at least one sub-processor. The memory may include one or more memories.

The refrigerator according to an embodiment of the disclosure may include a processor and a memory for controlling all of the components included in the refrigerator, and may include a plurality of processors and a plurality of memories for individually controlling the components of the refrigerator. For example, the refrigerator may include a processor and a memory for controlling the operation of the cold air supply device in accordance with to an output of the temperature sensor. In addition, the refrigerator may be separately provided with a processor and a memory for controlling the operation of the user interface in accordance with the user input.

A communication module may communicate with external devices, such as servers, mobile devices, and other home appliances via a nearby access point (AP). The AP may connect a local area network (LAN) to which a refrigerator or a user device is connected to a wide area network (WAN) to which a server is connected. The refrigerator or the user device may be connected to the server via the WAN.

The input interface may include keys, a touch screen, a microphone, and the like. The input interface may receive the user input and pass the received user input to the processor.

The output interface may include a display, a speaker, and the like. The output interface may output various notifications, messages, information, and the like generated by the processor.

As used in the following description, the terms “front-to-back direction”, “left-to-right direction”, “upper side”, “lower side”, and the like are defined based on the drawings, and the shape and position of each configuration are not limited by these terms.

For example, an X direction may be defined as a front-to-back direction. For example, a Y direction may be defined as a lateral direction. For example, a Z direction may be defined as an up-and-down direction. For example, the +X direction may be defined as forward, and the −X direction may be defined as rearward. For example, the +Y direction may be defined as right, and the −Y direction may be defined as left. For example, the +Z direction may be defined as upward, and the −Z direction may be defined as downward.

Hereinafter, an embodiment according to the present disclosure will be described in detail with reference to the accompanying drawings.

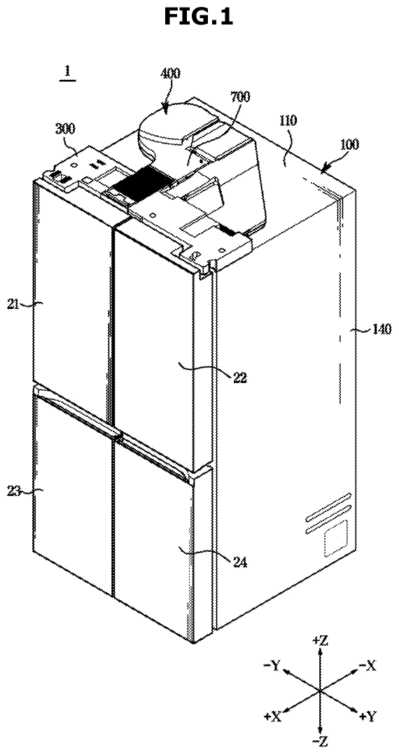

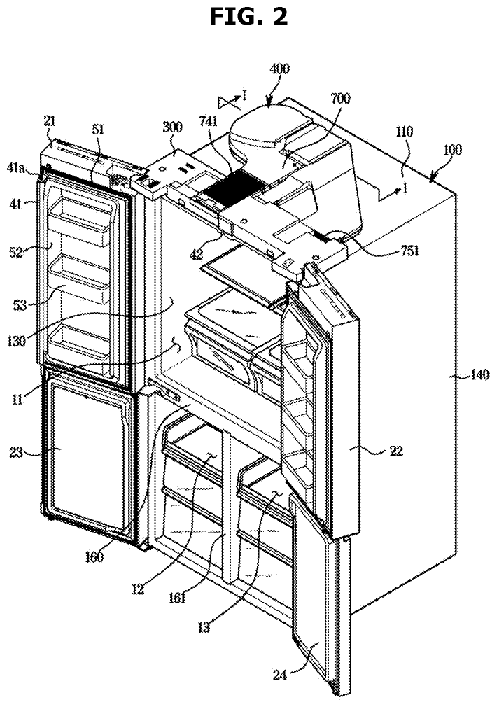

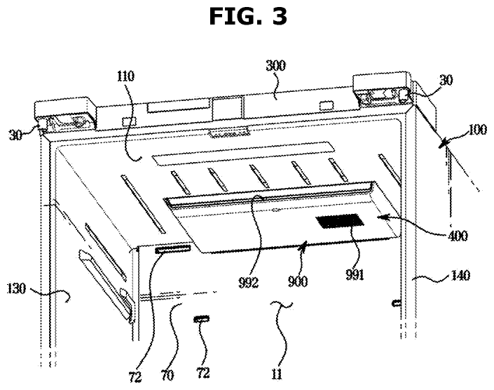

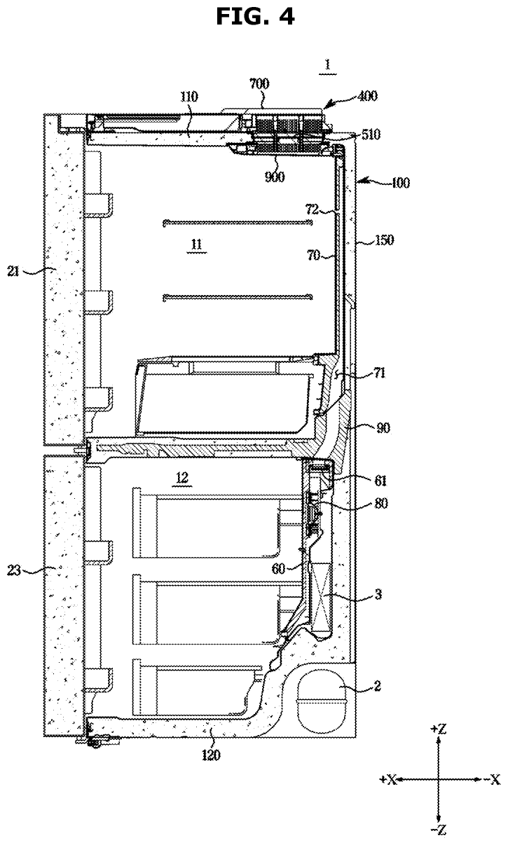

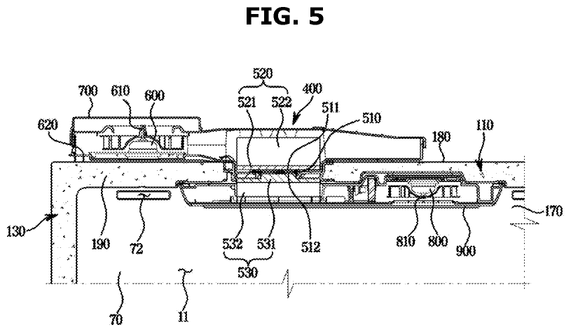

FIG. 1 is a perspective view illustrating a refrigerator according to an embodiment. FIG. 2 is a perspective view illustrating a state in which doors of the refrigerator according to an embodiment are opened. FIG. 3 is a view illustrating an upper portion of a storage compartment of the refrigerator according to an embodiment, viewed from below. FIG. 4 is a side cross-sectional view schematically illustrating the refrigerator according to an embodiment. FIG. 5 is a cross-sectional view taken along line I-I indicated in FIG. 2.

Referring to FIGS. 1 to 5, a refrigerator 1 may include a main body 100, a plurality of storage compartments 11, 12 and 13 provided inside the main body 100, and a plurality of doors 21, 22, 23 and 24 configured to open or close the plurality of storage compartments 11, 12 and 13.

The main body 100 may include an inner case 170, an outer case 180 coupled to an outer side of the inner case 170, and an insulation 190 disposed between the inner case 170 and the outer case 180. The inner case 170 may form each of the plurality of storage compartments 11, 12 and 13, and the outer case 180 may form an appearance of the main body 100.

The main body 100 may include an upper wall 110, a lower wall 120, a left wall 130, a right wall 140, and a rear wall 150. The upper wall 110, the lower wall 120, the left wall 130, the right wall 140, and the rear wall 150 may form an upper surface (+Z direction), a lower surface (−Z direction), a left surface (−Y direction), a right surface (+Y direction), and a rear surface (−X direction) of the main body 100, respectively.

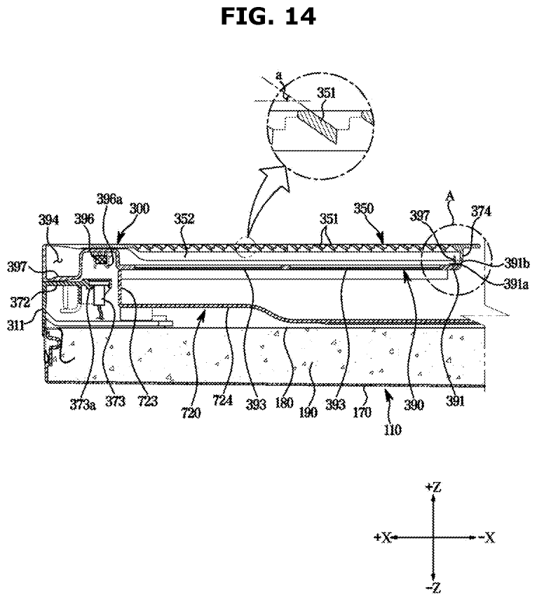

The upper wall 110, the lower wall 120, the left wall 130, the right wall 140, and the rear wall 150 may each be formed of the inner case 170, the outer case 180, and the insulation 190. In an example, an upper surface of the upper wall 110 may be formed by the outer case 180, a lower surface of the upper wall 110 may be formed by the inner case 170, and the insulation 190 may be provided inside the upper wall 110 (see FIG. 14).

Each of the plurality of storage compartments 11, 12 and 13 may accommodate items. Each of the plurality of storage compartments 11, 12 and 13 may be formed to be open at a front side to allow items to be put in or taken out.

The plurality of storage compartments 11, 12 and 13 may include a first storage compartment 11, a second storage compartment 12, and a third storage compartment 13. The first storage compartment 11 may be provided in an upper portion of the main body 100, and the second storage compartment 12 and the third storage compartment 13 may be provided in a lower portion of the main body 100. The first storage compartment 11 may be a refrigerating compartment, the second storage compartment 12 may be a freezing compartment, and the third storage compartment 13 may be a variable temperature compartment. The main body 100 may include a horizontal partition wall 160 that partitions the first storage compartment 11 from the second storage compartment 12 and the third storage compartment 13, and a vertical partition wall 161 that partitions the second storage compartment 12 from the third storage compartment 13.

Each of the plurality of doors 21, 22, 23 and 24 may be configured to open or close one of the plurality of storage compartments 11, 12 and 13.

The plurality of doors 21, 22, 23 and 24 may include a first door 21, a second door 22, a third door 23, and a fourth door 24. The first door 21 and the second door 22 may open or close the first storage compartment 11, the third door 23 may open or close the second storage compartment 12, and the fourth door 24 may open or close the third storage compartment 13.

Each of the plurality of doors 21, 22, 23 and 24 may be rotatably coupled to the main body 100. Specifically, each of the plurality of doors 21, 22, 23 and 24 may be rotatably coupled to the main body 100 by a hinge.

For example, the first door 21 and the second door 22 may each be rotatably coupled to the main body 100 by a hinge 30 provided at an upper portion of the main body 100 and a hinge (not shown) provided at a middle of the main body 100. The hinge 30 may be covered by a top cover 300 configured to cover a front portion of the upper surface of the main body 100.

The refrigerator 1 may include a rotating bar 41. The rotating bar 41 may be configured to cover a gap formed between the first door 21 and the second door 22 when the first door 21 and the second door 22 are closed. The rotating bar 41 may have a rod shape elongated in an up-and-down direction (Z-axis direction). The rotating bar 41 may also be referred to as a pillar, a mullion, or the like.

The rotating bar 41 may be rotatably provided on any one of the first door 21 and the second door 22. While the rotating bar 41 is shown in the drawings as being rotatably provided on the first door 21, the rotating bar 41 may also be rotatably provided on the second door 22.

The rotating bar 41 may include a guide protrusion 41a provided on an upper end of the rotating bar 41. A rotation guide 42 for guiding rotation of the guide protrusion 41a may be provided on the upper portion of the main body 100. When the first door 21 and the second door 22 are closed, the rotation guide 42 may guide the rotation of the guide protrusion 41a, thereby allowing the rotating bar 41 to rotate. This may allow the gap formed between the first door 21 and the second door 22 to be covered.

Each of the plurality of doors 21, 22, 23 and 24 may include a gasket 51. The gasket 51 may be in close contact with a front surface of the main body 100 when each of the plurality of doors 21, 22, 23 and 24 is closed.

Each of the plurality of doors 21, 22, 23 and 24 may include a dyke 52 protruding rearwardly. The dyke 52 may be equipped with a door shelf 53 for storing items. The rotating bar 41 may be rotatably mounted on the dyke 52.

Although the number and arrangement of the storage compartments and the number and arrangement of the doors have been described above, there is no limitation on the number and arrangement of the storage compartments and the number and arrangement of the doors of the refrigerator according to an embodiment of the present disclosure.

The refrigerator 1 may include a thermoelectric cooling device 400 configured to cool the first storage compartment 11.

The thermoelectric cooling device 400 may be arranged on an upper side of the first storage compartment 11 to cool the first storage compartment 11. In other words, the thermoelectric cooling device 400 may be arranged on the upper wall 110 of the main body 100.

The thermoelectric cooling device 400 may include a thermoelectric element 510. The thermoelectric element 510 may be a semiconductor element that utilizes a thermoelectric effect to convert thermal energy into electrical energy, and may also be referred to as a thermoelectric semiconductor element, a Peltier element, or the like. The thermoelectric element 510 may have a thin hexahedral shape.

The thermoelectric element 510 may include a heat generating portion 511 and a heat absorbing portion 512. When a current is applied to the thermoelectric element 510, a heat generating action may occur at the heat generating portion 511 and a heat absorbing action may occur at the heat absorbing portion 512. The heat generating portion 511 may be provided on one surface of the thermoelectric element 510, and the heat absorbing portion 512 may be provided on an opposite surface thereof.

The thermoelectric element 510 may be provided on the upper wall 110. The thermoelectric element 510 may be arranged such that the heat generating portion 511 faces upward of the thermoelectric element 510 and the heat absorbing portion 512 faces downward of the thermoelectric element 510. In other words, the heat generating portion 511 may be provided on an upper surface of the thermoelectric element 510, and the heat absorbing portion 512 may be provided on a lower surface of the thermoelectric element 510. The heat generating portion 511 may face an outside of the main body 100, and the heat absorbing portion 512 may face an inside of the first storage compartment 11. Accordingly, air warmed by heat exchange with the heat generating portion 511 may be discharged to the outside of the main body 100, and air cooled by heat exchange with the heat absorbing portion 512 may be supplied to the first storage compartment 11.

The thermoelectric cooling device 400 may include a heat sink 520 in contact with the heat generating portion 511 such that heat exchange between the heat generating portion 511 and the air outside the main body 100 is efficient. The heat sink 520 may be provided on an upper side of the thermoelectric element 510 to contact the heat generating portion 511.

The heat sink 520 may be provided outside the main body 100. The heat sink 520 may contact the heat generating portion 511 to absorb heat from the heat generating portion 511 and dissipate heat to the outside of the main body 100. The heat sink 520 may also be referred to as a hot sink, a heat dissipating sink, a hot heat sink, or the like.

The heat sink 520 may be formed of a metal material having good thermal conductivity. For example, the heat sink 520 may be formed of an aluminum or copper.

The heat sink 520 may include a heat sink base 521 in contact with the heat generating portion 511, and a plurality of heat sink fins 522 protruding from the heat sink base 521 to increase a heat transfer area. The plurality of heat sink fins 522 may protrude upwardly from the heat sink base 521.

The thermoelectric cooling device 400 may include a cooling sink 530 in contact with the heat absorbing portion 512 such that heat exchange between the heat absorbing portion 512 and the air inside the first storage compartment 11 is efficient. The cooling sink 530 may be provided on a lower side of the thermoelectric element 510 to contact the heat absorbing portion 512.

The cooling sink 530 may be provided inside the first storage compartment 11. The cooling sink 530 may take heat from the first storage compartment 11 and transfer the heat to the heat absorbing portion 512, thereby cooling the first storage compartment 11. The cooling sink 530 may also be referred to as a cold sink, a cooling sink, a cooling heat sink, a cold heat sink, a chilling heat sink, or the like.

The cooling sink 530 may be formed of a metal material having good thermal conductivity. For example, the cooling sink 530 may be formed of an aluminum or copper.

The cooling sink 530 may include a cooling sink base 531 in contact with the heat absorbing portion 512, and a plurality of cooling fins 532 protruding from the cooling sink base 531 to increase the heat transfer area. The plurality of cooling fins 532 may protrude downwardly from the cooling sink base 531. The cooling sink base 531 and the plurality of cooling fins 532 may be integrally formed.

The thermoelectric cooling device 400 may include a heat dissipation fan 600 that flows air to efficient heat exchange between the heat sink 520 and air outside the main body 100.

The heat dissipation fan 600 may be configured to draw in the air from outside the main body 100 and blow the air toward the heat sink 520. The heat dissipation fan 600 may be arranged to be positioned in a horizontal direction of the heat sink 520. The heat dissipation fan 600 may be provided outside the main body 100. The heat dissipation fan 600 may be provided on an upper side of the upper wall 110.

The heat dissipation fan 600 may be a centrifugal fan that draws in air in an axial direction and discharges the air in a radial direction. The centrifugal fan may include a blower fan. A rotational shaft 610 of the heat dissipation fan 600 may be arranged perpendicularly to the upper surface of the upper wall 110.

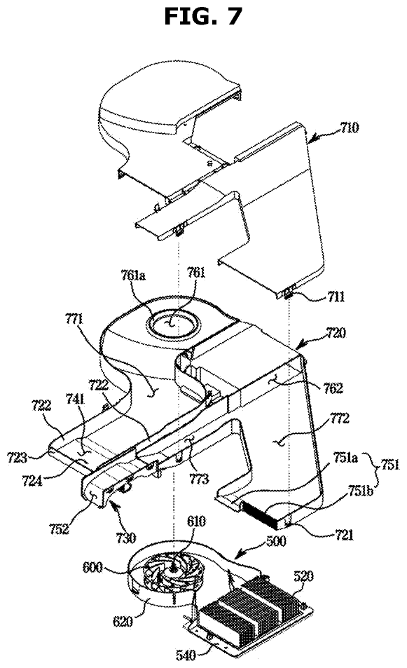

The thermoelectric cooling device 400 may include a fan case 620 in which the heat dissipation fan 600 is installed and which guides the air blown by the heat dissipation fan 600. The rotational shaft 610 of the heat dissipation fan 600 may be installed perpendicularly to a bottom of the fan case 620 (see FIG. 7).

The thermoelectric cooling device 400 may include a heat dissipation duct 700 configured to guide air flowing by the heat dissipation fan 600. The heat dissipation duct 700 may be configured to draw in air from outside the main body 100, guide the air to heat exchange with the heat sink 520, and discharge the air that has exchanged heat with the heat sink 520 back to the outside of the main body 100.

The heat dissipation duct 700 may draw in air from an external space on an upper side of the main body 100. The heat dissipation duct 700 may discharge the air that has exchanged heat with the heat sink 520 to the external space on the upper side of the main body 100. The heat dissipation fan 600 may be located inside the heat dissipation duct 700. The heat sink 520 may be located inside the heat dissipation duct 700. The heat dissipation duct 700 may be provided on the upper surface of the upper wall 110.

The heat dissipation duct 700 may include an outside air inlet 741 drawing in air from outside the main body 100 into the interior of the heat dissipation duct 700, and an outside air outlet 751 discharging the air that has exchanged heat with the heat sink 520 to the outside of the main body 100.

The thermoelectric cooling device 400 may include a cooling fan 800 that flows air to efficient heat exchange between the cooling sink 530 and air inside the first storage compartment 11.

The cooling fan 800 may be configured to draw in air within the first storage compartment 11 and blow the air toward the cooling sink 530. The cooling fan 800 may be positioned in a horizontal direction of the cooling sink 530. The cooling fan 800 may be provided inside the first storage compartment 11. The cooling fan 800 may be provided on a lower side of the upper wall 110.

The cooling fan 800 may be a centrifugal fan that draws in air in an axial direction and discharges the air in a radial direction. A rotational shaft 810 of the cooling fan 800 may be arranged perpendicularly to the lower surface of the upper wall 110.

The thermoelectric cooling device 400 may include a cooling duct 900 configured to guide air flowing by the cooling fan 800. The cooling duct 900 may draw in air from inside the first storage compartment 11, guide the air to heat exchange with the cooling sink 530, and discharge the air that has exchanged heat with the cooling sink 530 back into the interior of the first storage compartment 11.

The cooling duct 900 may be positioned on an upper side of the first storage compartment 11. Specifically, the cooling duct 900 may be arranged on the lower surface of the upper wall 110.

The cooling fan 800 may be positioned inside the cooling duct 900. The cooling sink 530 may be positioned inside the cooling duct 900.

The cooling duct 900 may include an inside air inlet 991 configured to draw in air within the first storage compartment 11 into the interior of the cooling duct 900, and an inside air outlet 992 configured to discharge the air that has exchanged heat with the cooling sink 530 into the interior of the first storage compartment 11.

Referring to FIG. 4, the refrigerator 1 may include a refrigeration cycle device to cool the storage compartments through a refrigeration cycle. The refrigeration cycle device may include a compressor 2, a condenser (not shown), an expansion device (not shown), and an evaporator 3. The evaporator 3 may be arranged at a rear side of the second storage compartment 12 and the third storage compartment 13.

The refrigerator 1 may include evaporator ducts 60 and 70 that guide cold air generated in the evaporator 3. The evaporator ducts 60 and 70 may include a first evaporator duct 60 and a second evaporator duct 70. The first evaporator duct 60 may be arranged at a rear side of the second storage compartment 12 and the third storage compartment 13. The second evaporator duct 70 may be arranged at a rear side of the first storage compartment 11.

The cold air generated in the evaporator 3 may be drawn into the interior of the first evaporator duct 60 by an evaporator fan 80. The cold air drawn into the interior of the first evaporator duct 60 may be discharged to the second storage compartment 12 or the third storage compartment 13 through a cold air outlet (not shown) formed at a front face thereof. Furthermore, the cold air drawn into the interior of the first evaporator duct 60 may be directed to an inner flow path 71 of the second evaporator duct 70. The first evaporator duct 60 may be provided with a damper 61 that controls the supply of the cold air inside the first evaporator duct 60 to the second evaporator duct 70. A connection duct 90 may be provided between the first evaporator duct 60 and the second evaporator duct 70 to communicate between the first evaporator duct 60 and the second evaporator duct 70.

Cold air introduced into the inner flow path 71 of the second evaporator duct 70 may be supplied to the first storage compartment 11 through a cold air outlet 72 formed at a front face of the second evaporator duct 70.

As such, according to an embodiment of the present disclosure, the refrigerator may include the thermoelectric cooling device and the refrigeration cycle device, but the present disclosure is not limited thereto, and the refrigerator may include simply the thermoelectric cooling device 400.

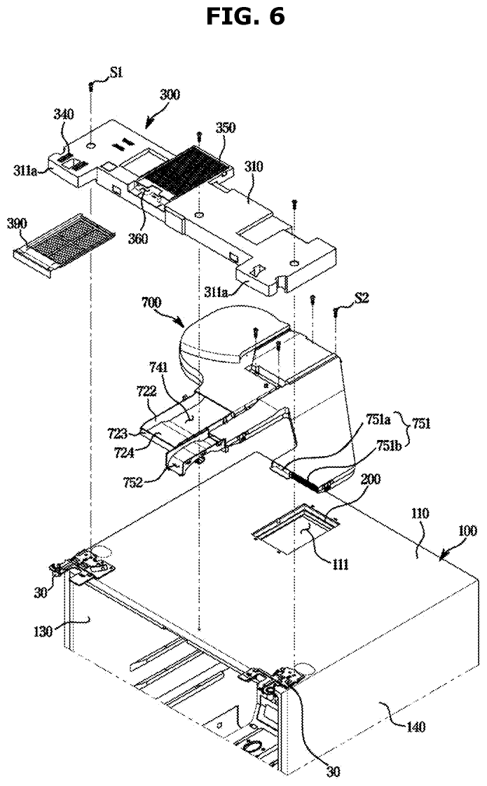

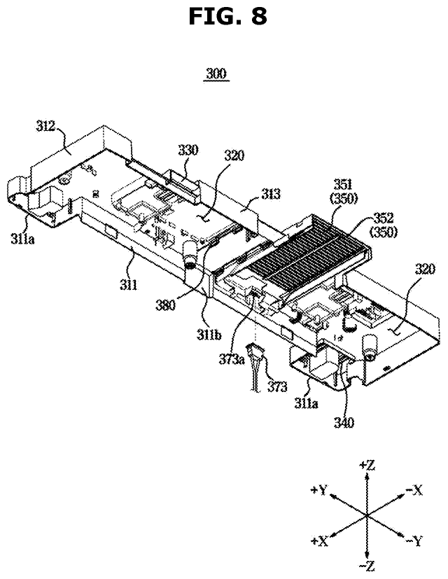

FIG. 6 is a view illustrating a top cover, a dust filter, and a heat dissipation duct separated from a main body, according to an embodiment. FIG. 7 is a view illustrating a heat dissipation duct cover, a heat dissipation duct body, and a thermoelectric module separated from each other, according to an embodiment. FIG. 8 is a perspective view illustrating a lower surface of a top cover according to an embodiment.

Referring to FIGS. 6 to 8, a through-hole 111 that connects the inside of the storage compartment 11 and the outside of the main body 100 may be formed in the upper wall 110 of the main body 100. The main body 100 may include a connection frame 200 disposed between the inner case 170 and the outer case 180 to form the through-hole 111.

The thermoelectric cooling device 400 may include a thermoelectric module 500. The thermoelectric module 500 may include the thermoelectric element 510, the heat sink 520, the cooling sink 530, and a module plate 540. The thermoelectric module 500 may be configured to penetrate the through-hole 111 of the upper wall 110 such that the heat sink 520 is located outside the main body 100 and the cooling sink 530 is located inside the storage compartment 11.

The module plate 540 may serve as a framework of the thermoelectric module. The module plate 540 may be formed of a resin material having a low thermal conductivity. The module plate 540 may support the heat sink 520 and the cooling sink 530, respectively. The module plate 540 may be integrally formed with the fan case 620, or may be separately provided.

The thermoelectric cooling device 400 may include the heat dissipation duct 700 coupled to the upper wall 110 of the main body 100 to guide the air flowing by the heat dissipation fan 600 to heat exchange with the heat sink 520. The heat dissipation duct 700 may be configured to draw in air from outside the main body 100 to exchange heat with the heat sink 520, and discharge the air that has exchanged heat with the heat sink 520 back to the outside of the main body 100.

The heat dissipation duct 700 may include a heat dissipation duct cover 710, a heat dissipation duct body 720, and an extension duct 730.

The heat dissipation duct cover 710 may cover an upper side of the heat dissipation duct body 720. The heat dissipation duct cover 710 may be coupled to an upper portion of the heat dissipation duct body 720 to cover the upper side of the heat dissipation duct body 720. To this end, the heat dissipation duct cover 710 may be provided with a duct cover coupling portion 711, and the heat dissipation duct body 720 may be provided with a duct body coupling portion 721 coupled to the duct cover coupling portion 711. The duct cover coupling portion 711 and the duct body coupling portion 721 may be coupled in a hooked or snapped manner.

The heat dissipation duct body 720 may be coupled to the upper wall 110 of the main body 100. The heat dissipation duct body 720 may cover the heat dissipation fan 600 and the heat sink 520. The outside air inlet 741 may be formed on an upper surface of a front portion of the heat dissipation duct body 720. Specifically, the upper surface of the front portion of the heat dissipation duct body 720 may include a bottom 724, a front wall portion 723 extending upward from a front end of the bottom 724, and side wall portions 722 extending upward from both side ends of the bottom 724, wherein the bottom 724, the front wall portion 723, and the side wall portions 722 may form the outside air inlet 741.

The extension duct 730 may be provided at a front of the heat dissipation duct body 720. The extension duct 730 may be connected to the heat dissipation duct body 720. The extension duct 730 may be integrally formed with the heat dissipation duct body 720, or may be formed separately from the heat dissipation duct body 720.

The extension duct 730 may be disposed below the top cover 300. The extension duct 730 may be coupled to a lower portion of the top cover 300. An upper side of the extension duct 730 may be covered by the top cover 300.

The heat dissipation duct 700 may include the outside air inlet 741 configured to draw in the air outside the main body. The outside air inlet 741 may be formed in the heat dissipation duct body 720.

Specifically, the outside air inlet 741 may be formed on an upper surface of the heat dissipation duct body 720. The outside air inlet 741 may be positioned closer to the front surface of the main body 100 than to the rear surface of the main body 100. In other words, the outside air inlet 741 may be positioned closer to a front end portion of the upper surface of the main body 100 relative to a central portion of the upper surface of the main body 100.

As such, the reason why the outside air inlet 741 is located closer to the front surface of the main body 100 than the rear surface of the main body 100 is to suppress heat generated from the compressor 2 and the evaporator 3 located at the rear of the main body 100 from being drawn in through the outside air inlet 741.

The heat dissipation duct 700 may include a plurality of outside air outlets 751 and 752 that discharges air that has exchanged heat with the heat sink 520 to the outside of the main body 100.

The plurality of outside air outlets 751 and 752 may include a first outside air outlet 751. The first outside air outlet 751 may discharge the air that has exchanged heat with the heat sink 520 toward the external space on the upper side of the main body 100.

The plurality of outside air outlets 751 and 752 may include a second outside air outlet 752. The second outside air outlet 752 may discharge the air that has exchanged heat with the heat sink 520 toward the rotating bar 41. With such a configuration, condensation phenomenon may be prevented from occurring on the rotating bar 41.

However, the heat dissipation duct 700 does not necessarily need to include both the first outside air outlet 751 and the second outside air outlet 752. For example, the second outside air outlet 752 may be omitted.

The heat dissipation duct 700 may include a fan receiving space 761 that receives the heat dissipation fan 600. The fan receiving space 761 may be formed on a lower surface of the heat dissipation duct body 720.

The heat dissipation duct 700 may include a fan inlet 761a configured to introduce air into the fan receiving space 761. The fan inlet 761a may be provided on an upper side of the fan receiving space 761.

The heat dissipation duct 700 may include a sink receiving space 762 configured to receive the heat sink 520. The sink receiving space 762 may be formed on the lower surface of the heat dissipation duct body 720. The sink receiving space 762 may be formed on a downstream side of the fan receiving space 761.

The heat dissipation duct body 720 may include an intake space 771 formed on the upper surface of the heat dissipation duct body 720 to guide air drawn in through the outside air inlet 741 to the fan receiving space 761. An upper side of the intake space 771 may be formed to be open, and the open upper side of the intake space 771 may be covered by the heat dissipation duct cover 710. The intake space 771 may be formed on an upstream side of the fan receiving space 761. The intake space 771 may be connected to the fan receiving space 761 via the fan inlet 761a.

The heat dissipation duct body 720 may include a first discharge space 772 formed on the upper surface of the heat dissipation duct body 720 to guide air that has exchanged heat with the heat sink 520 to the first outside air outlet 751. An upper side of the first discharge space 772 may be open, and the open upper side of the first discharge space may be covered by the heat dissipation duct cover 710. The first discharge space 772 may be formed on a downstream side of the sink receiving space 762.

The heat dissipation duct body 720 may include a second discharge space 773 formed on the upper surface of the heat dissipation duct body 720 to guide the air that has exchanged heat with the heat sink 520 to the second outside air outlet 752. An upper side of the second discharge space 773 may be open, and the open upper side of the second discharge space 773 may be covered by the heat dissipation duct cover 710. The second discharge space 773 may be formed on a downstream side of the sink receiving space 762.

The thermoelectric module 500 and the heat dissipation duct 700 may be coupled to the upper wall 110 of the main body 100 by at least one fastening member S2. The at least one fastening member S2 may pass through the heat dissipation duct 700 and the thermoelectric module 500 in turn and may be fastened to the connection frame 200 of the main body 100.

The refrigerator 1 may include the top cover 300 coupled to the front portion of the upper wall 110 of the main body 100.

The top cover 300 may include a top cover upper surface portion 310, a top cover front surface portion 311 extending downwardly from a front edge of the top cover upper surface portion 310, top cover side surface portions 312 extending downwardly from both side edges of the top cover upper surface portion 310, a top cover rear surface portion 313 extending downwardly from a rear edge of the top cover upper surface portion 310, and a top cover internal space 320 formed by the top cover upper surface portion 310, the top cover front surface portion 311, the top cover side surface portions 312, and the top cover rear surface portion 313. A lower side of the top cover internal space 320 may be open, and the open lower side of the top cover internal space 320 may be covered by the upper surface of the upper wall 110.

The top cover 300 may include front protrusions 311a protruding forwardly from both end portions of the top cover front surface portion 311 to cover the hinges 30.

The top cover 300 may include an outlet formation 311b formed on the top cover front surface portion 311 of the top cover 300 to form, together with the extension duct 730, the second outside air outlet 752. The outlet formation 311b may protrude forward from the top cover front surface portion 311.

The top cover 300 may be coupled to the upper wall 110 of the main body 100 via at least one fastening member S1. The thermoelectric module 500 and the heat dissipation duct 700 may be coupled to the upper wall 110 of the main body 100 and then the top cover 300 may be coupled to the upper wall 110 of the main body 100.

At least a portion of the top cover 300 may be disposed on an upper side of the heat dissipation duct 700 to overlap the heat dissipation duct 700. Specifically, an air inlet portion 350, which will be described later, of the top cover 300 may be disposed to cover the outside air inlet 741 of the heat dissipation duct 700.

The thermoelectric cooling device 400 may include a dust filter 390 configured to filter out foreign matter, such as dust, from the air entering the outside air inlet 741. The dust filter 390 may be detachably mounted to the top cover 300. Specifically, the dust filter 390 may be detachably mounted to a filter receiving space 360 by sliding in a front-to-back direction.

The top cover 300 may include the filter receiving space 360 configured to receive the dust filter 390. The air inlet portion 350, which will be described later, may be provided at one side of the filter receiving space 360. The filter receiving space 360 may be provided at a position corresponding to the outside air inlet 741 of the heat dissipation duct 700. When the dust filter 390 is mounted in the filter receiving space 360, the dust filter 390 may be supported by a fixed rail portion 371 and a front support portion 372, which will be described later.

At least a portion of the air discharged from the heat dissipation duct 700 via the first outside air outlet 751 may be introduced into the top cover internal space 320. In other words, a portion of the air warmed by heat exchange with the heat sink 520 may be introduced into the top cover internal space 320. To this end, the top cover 300 may have a top cover inlet 330. The top cover inlet 330 may be formed in the top cover rear surface portion 313.

The first outside air outlet 751 may include a connection 751a configured to guide air inside the heat dissipation duct 700 to the top cover internal space 320. The connection 751a may be connected to the top cover inlet 330 of the top cover 300. The air discharged through the connection 751a may be introduced into the top cover internal space 320 through the top cover inlet 330.

The first outside air outlet 751 may include an external outlet 751b partitioned from the connection 751a to discharge air from the heat dissipation duct 700 to the outside of the top cover 300. The external outlet 751b may have an outlet grille formed to prevent foreign matter from entering the heat dissipation duct 700 through the external outlet 751b.

The air introduced into the top cover internal space 320 may pass through the top cover internal space 320 and be discharged to the outside of the top cover 300. To this end, the top cover 300 may include a top cover outlet 340. The top cover outlet 340 may be formed in the front protrusion 311a of the top cover 300. The top cover outlet 340 may be formed in the front protrusion 311a that is further away from the top cover inlet 330 of the front protrusions 311a. In other words, the top cover inlet 330 may be formed closer to the right hinge and the top cover outlet 340 may be formed closer to the left hinge.

The top cover outlet 340 may be formed on an upper surface of the front protrusion 311a. With such a configuration, air exiting through the top cover outlet 340 may be inhibited from being redrawn into the outside air inlet 741.

The air that has exchanged heat with the heat sink 520 may heat the upper wall 110 of the main body 100 as it passes through the top cover internal space 320. With such a configuration, condensation phenomenon on the front portion of the front surface of the main body 100 may be prevented.

The top cover 300 may be provided with a top cover coupling portion 380 coupled to the extension duct 730. The top cover coupling portion 380 may be coupled to the extension duct 730 in a hooked or snapped manner.

The top cover 300 may be provided with a filter sensor 373 that detects whether the dust filter 390 is mounted in the filter receiving space 360. The top cover 300 may be provided with a sensor mounting portion 373a in which the filter sensor 373 is mounted.

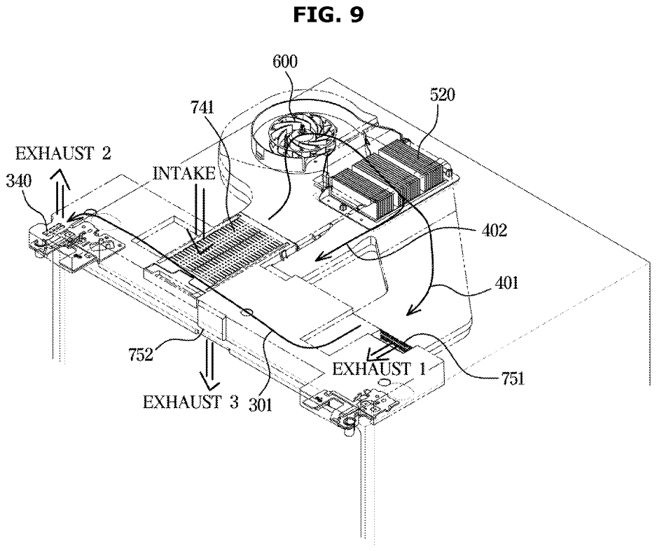

FIG. 9 is a view illustrating a flow of air by a heat dissipation fan, a heat dissipation duct, and a top cover, according to an embodiment.

Referring to FIG. 9, the refrigerator 1 may include a first heat dissipation flow path 401 through which the air that has exchanged heat with the heat sink 520 is discharged to the outside of the main body 100, and a second heat dissipation flow path 402 through which the air that has exchanged heat with the heat sink 520 is discharged toward the rotating bar 41. The second heat dissipation flow path 402 may be formed by branching from the first heat dissipation flow path 401.

A portion of the air drawn in through the outside air inlet 741 may be discharged to the outside of the main body 100 through the first heat dissipation flow path 401. In other words, a portion of the air drawn in through the outside air inlet 741 may exchange heat with the heat sink 520 and then be discharged to the outside of the main body 100 through the first outside air outlet 751 (see “exhaust 1” in FIG. 9).

Another portion of the air drawn in through the outside air inlet 741 may be discharged to the outside of the main body 100 through the first heat dissipation flow path 401 and a top cover flow path 301. In other words, a portion of the air drawn in through the outside air inlet 741 may exchange heat with the heat sink 520, pass through the interior of the top cover 300, and then be discharged to the outside of the main body 100 through the top cover outlet 340 formed in the top cover 300 (see “exhaust 2” in FIG. 9).

A portion of the air drawn in through the outside air inlet 741 may be discharged toward the rotating bar 41 through the second heat dissipation flow path 402. In other words, a portion of the air drawn in through the outside air inlet 741 may exchange heat with the heat sink 520 and then be discharged downward toward the rotating bar 41 through the second outside air outlet 752 (see “Exhaust 3” in FIG. 9).

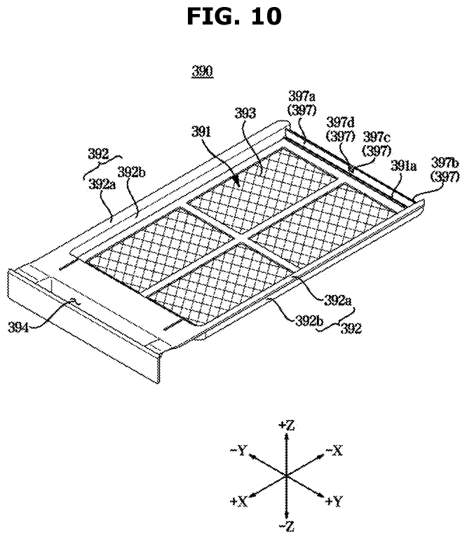

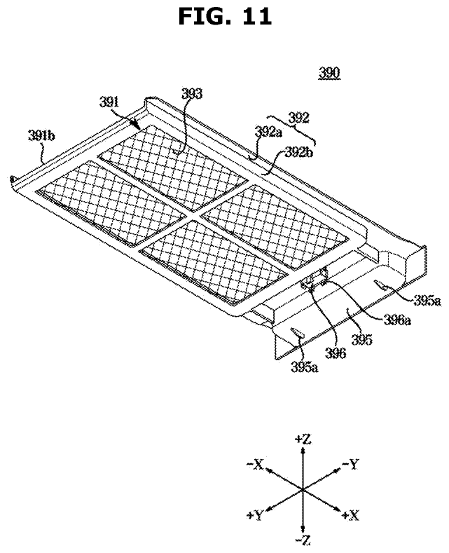

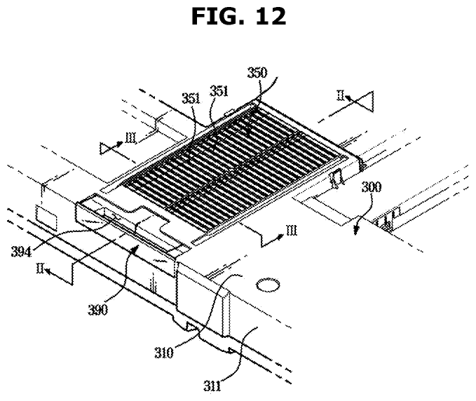

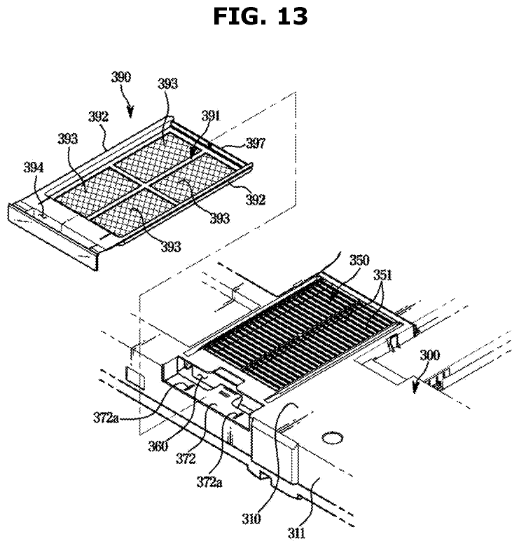

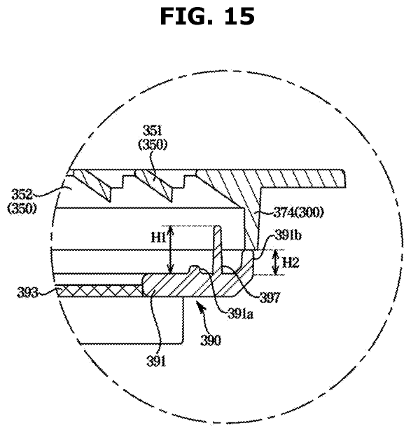

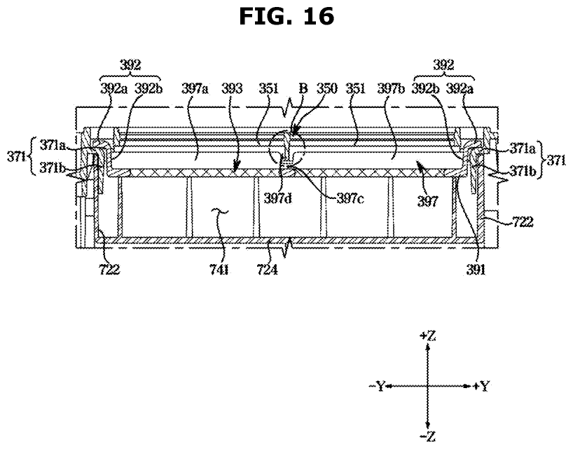

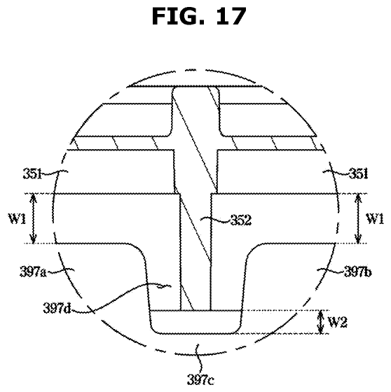

FIG. 10 is a perspective view illustrating a dust filter according to an embodiment. FIG. 11 is a perspective view illustrating a lower surface of the dust filter shown in FIG. 10. FIG. 12 is a perspective view illustrating a state in which a dust filter is mounted to the top cover according to an embodiment. FIG. 13 is a perspective view illustrating a state in which the dust filter is separated from the top cover shown in FIG. 12. FIG. 14 is a cross-sectional view taken along line II-II indicated in FIG. 12. FIG. 15 is an enlarged view of portion A indicated in FIG. 14. FIG. 16 is a cross-sectional view taken along line III-III of FIG. 12. FIG. 17 is an enlarged view of portion B indicated in FIG. 16.

Referring to FIGS. 10 to 17, the structure of the dust filter 390 according to an embodiment of the present disclosure will be described in detail.

As described above, the heat dissipation duct 700 may include the outside air inlet 741 formed on the upper surface of the heat dissipation duct 700 to draw in the air from outside the main body into the interior of the heat dissipation duct 700, and the outside air inlet 741 may have the dust filter 390 disposed therein for preventing foreign matter from entering through the outside air inlet 741.

The dust filter 390 may include a filter member 393 for filtering out foreign matter, such as dust, in the air, and a filter frame 391 for supporting the filter member 393. The filter member 393 may be any type of filter member for filtering or removing contaminants, bacteria, viruses, dust, and the like from the air. The filter member 393 may have a mesh shape.

The filter frame 391 may be formed to surround the filter member 393. The filter frame 391 may generally have a rectangular shape. The filter frame 391 may support the filter member 393 such that the filter member 393 is laid flat.

The filter frame 391 may include a reinforcing rib 391a configured to prevent the dust filter 390 from being deflected. The reinforcing rib 391a may be provided at a rear end portion of the filter frame 391. Specifically, the reinforcing rib 391a may be formed to protrude upwardly from the rear end portion of the filter frame 391. The reinforcing rib 391a may extend in a left-to-right direction. The reinforcing rib 391a may be provided at a rear of the filter member 393. However, the position of the reinforcing rib 391a is not limited thereto.

The filter frame 391 may include a rear wall 391b provided at the rear end portion thereof. Specifically, the rear wall 391b may be formed to protrude upwardly from the rear end portion of the filter frame 391. The rear wall 391b may be formed at a rearmost end of a plane on which the filter member 393 is formed.

The top cover 300 may include a barrier wall 374 provided at a rear side of the filter receiving space 360. The barrier wall 374 may be provided at a rear of the air inlet portion 350. The barrier wall 374 may be formed to extend downwardly from a plane on which the air inlet portion 350 is formed.

When the dust filter 390 is mounted in the filter receiving space 360, the rear wall 391b of the filter frame 391 and the barrier wall 374 of the top cover 300 may contact each other. With such a configuration, when the dust filter 390 is mounted in the filter receiving space 360, dust filtered by the filter member 393 may be prevented from traveling to the rear of the filter frame 391 and entering the heat dissipation duct 700.

The dust filter 390 may include a handle 394 formed to be recessed on an upper surface of a front portion of the dust filter 390. When the dust filter 390 is mounted in the filter receiving space 360, the handle 394 may be positioned at a front of the top cover 300. By gripping the handle 394 located at the front of the top cover 300, a user of the refrigerator 1 may mount the dust filter 390 to the filter receiving space 360 or remove the dust filter 390 from the filter receiving space 360.

As described above, the dust filter 390 may be detachably mounted to the filter receiving space 360 by sliding in the front-to-back direction. Specifically, the dust filter 390 may be mounted to the filter receiving space 360 of the top cover 300 by sliding rearwardly, and may be detached from the filter receiving space 360 by sliding forwardly.

To this end, the dust filter 390 may include a pair of movable rail portions 392 formed on the filter frame 391 to extend in the front-to-back direction. The pair of movable rail portions 392 may be formed on one side and the other side of the filter frame 391, respectively. A pair of fixed rail portions 370 may be supported by the side wall portions 722 of the heat dissipation duct body 720.

Each of the pair of movable rail portions 392 may be formed to protrude from one end and the other end of the filter frame 391. Specifically, each of the pair of movable rail portions 392 may include a vertical movable rail portion 392b extending upwardly from the plane on which the filter member 393 is formed, and a horizontal movable rail portion 392a extending in a horizontal direction from the vertical movable rail portion 392b.

The top cover 300 may include a pair of fixed rail portions 371 that slidably supports the pair of movable rail portions 392 of the dust filter 390. In other words, the pair of movable rail portions 392 of the dust filter 390 may be slidably supported by the pair of fixed rail portions 371. The pair of fixed rail portions 371 may be provided on one side and the other side of the filter receiving space 360, respectively.

Each of the pair of fixed rail portions 371 may include a horizontal fixed rail portion 371a extending in the horizontal direction to support the horizontal movable rail portion 392a, and a vertical fixed rail portion 371b extending downwardly from the horizontal fixed rail portion 371a to support the vertical movable rail portion 392b.

As such, the horizontal movable rail portion 392a of the dust filter 390 may be supported by the horizontal fixed rail portion 371a of the top cover 300, and the vertical movable rail portion 392b of the dust filter 390 may be supported by the vertical fixed rail portion 371b of the top cover 300, so that the dust filter 390 may be stably supported on the top cover 300 in both the vertical and horizontal directions.

However, the dust filter 390 according to an embodiment of the present disclosure may be mounted in the filter receiving space 360 in a manner other than the sliding. For example, the dust filter 390 according to an embodiment may be mounted by being seated in the filter receiving space 360 in the vertical direction from the outside of the top cover 300, and may be removed by being lifted in the vertical direction from the filter receiving space 360.

The dust filter 390 may include a fixing protrusion 395a formed to protrude from a lower surface of the front portion of the filter frame 391. When the dust filter 390 is mounted in the filter receiving space 360 of the top cover 300, the fixing protrusion 395a may be coupled to the top cover 300 to ensure that the dust filter 390 remains mounted.

The top cover 300 may include a front support portion 372 that supports a front portion 395 of the filter frame 391. The front support portion 372 may include a fixing hole 372a into which the fixing protrusion 395a of the dust filter 390 is inserted. When the fixing protrusion 395a of the dust filter 390 is inserted into the fixing hole 372a of the top cover 300, the dust filter 390 may be secured to the top cover 300.

As described above, the top cover 300 may be provided with the filter sensor 373 that detects whether the dust filter 390 is mounted in the filter receiving space 360. Further, the top cover 300 may include the sensor mounting portion 373a in which the filter sensor 373 is mounted.

The sensor mounting portion 373a may be formed at a front portion of the top cover 300. The filter sensor 373 may be a reed switch including a plurality of reed pieces that may contact or separate from each other by a magnetic force. However, the filter sensor 373 is not limited thereto and may include a variety of sensors, such as a proximity sensor or a sensor utilizing infrared wavelengths.

The dust filter 390 may be provided with a magnet 396 that is capable of magnetically interacting with the reed switch. The dust filter 390 may include a magnet mounting portion 396a on which the magnet 396 can be mounted. When the dust filter 390 is mounted in the filter receiving space 360, the magnet mounting portion 396a of the dust filter 390 may be formed in a position corresponding to the sensor mounting portion 373a of the top cover 300. Specifically, when the dust filter 390 is mounted in the filter receiving space 360, the magnet 396 of the dust filter 390 may be positioned in the vertical direction of the filter sensor 373 of the top cover 300.

The filter sensor 373 may be in an on or off state depending on a separation distance from the magnet 396. For example, the filter sensor 373 may be in an off state when the separation distance from the magnet 396 is less than or equal to a predetermined distance, and may be in an on state when the separation distance from the magnet 396 is greater than the predetermined distance.

The refrigerator 1 may determine whether the dust filter 390 is installed or not based on state information of the filter sensor 373. Upon determining that the dust filter 390 is not installed, the refrigerator 1 may be provided to notify a user that the dust filter 390 is not installed through a display, a speaker, or the like.

The top cover 300 may include the air inlet portion 350 provided on an upper side of the filter receiving space 360. The air inlet portion 350 may guide the air drawn in through the outside air inlet 741. Specifically, when the dust filter 390 is installed in the filter receiving space 360, the air drawn in through the outside air inlet 741 may pass through the air inlet portion 350 and the dust filter 390 and enter the heat dissipation duct 700.

The air inlet portion 350 may include a plurality of grilles 351 spaced apart from each other. The plurality of grilles 351 may be arranged in the front-to-back direction. Between two grilles 351 adjacent to each other, an opening may be formed that is open to allow air to enter.

When the dust filter 390 is installed in the filter receiving space 360, the air inlet portion 350 may primarily block foreign matter from being drawn into the interior of the heat dissipation duct 700 through the plurality of grilles 351, prior to the dust filter 390. In addition, when the dust filter 390 is installed in the filter receiving space 360, the air inlet portion 350 may protect the dust filter 390 by blocking external forces from being applied to the dust filter 390 through the plurality of grilles 351.

Each of the plurality of grilles 351 may be formed to be inclined downwardly toward the rear. Stated differently, each of the plurality of grilles 351 may be arranged to be inclined at a predetermined angle a with respect to a horizontal plane.

The air inlet portion 350 may include a grille reinforcing rib 352 protruding downwardly from the plurality of grilles 351. The grille reinforcing rib 352 may extend in a direction intersecting each of the plurality of grilles 351. The grille reinforcing rib 352 may extend along a central portion of each of the plurality of grilles 351 based on the left-to-right direction. By means of the grille reinforcing rib 352, the stiffness of each of the plurality of grilles 351 may be improved.

The refrigerator 1 may determine when it is time to clean and replace the dust filter 390 based on information such as the number of revolutions per minute of the heat dissipation fan 600. The refrigerator 1 may be provided to notify a user that the dust filter 390 needs to be cleaned and replaced through a display, a speaker, or the like upon determining that the time to clean and replace the dust filter 390 has arrived.

As described above, since the dust filter 390 is located on the upper wall 110 of the main body 100, and the dust filter 390 may be mounted to and detached from the top cover 300 by sliding movement in the front-to-back direction, mounting, detachment, cleaning, and replacement of the dust filter 390 may be facilitated. As a result, the performance of the thermoelectric cooling device 400 may be continuously maintained.

While an embodiment in which the dust filter 390 is mounted to the top cover 300 has been described above, in some embodiments, the dust filter 390 may be configured to be mounted to the heat dissipation duct 700 rather than the top cover 300. In this case, the top cover 300 and the heat dissipation duct 700 may be configured not to stack on top of each other, or the top cover 300 itself may be omitted.

The filter frame 391 may include a rear rib 397 provided at the rear end portion of the filter frame 391. Specifically, the rear rib 397 may be formed to protrude upwardly from the rear end portion of the filter frame 391. In other words, when the dust filter 390 is mounted in the filter receiving space 360, the rear rib 397 may be formed to protrude from the rear end portion of the filter frame 391 toward the air inlet portion 350. When the dust filter 390 is removed from the filter receiving space 360, the rear rib 397 may prevent the dust filtered by the filter member 393 from traveling to the rear of the filter frame 391 and entering the heat dissipation duct 700.

The rear rib 397 may protrude substantially perpendicularly to the plane on which the filter member 393 is formed. In other words, when the dust filter 390 is mounted in the filter receiving space 360, the rear rib 397 may protrude toward a rear end portion of the air inlet portion 350.

The rear rib 397 may be provided at the rear of the filter member 393. In other words, when the dust filter 390 is mounted in the filter receiving space 360, the rear rib 397 may be positioned behind the filter member 393. Because the dust filtered by the filter member 393 is accumulated on the filter member 393, the rear rib 397 may be positioned behind the dust filtered by the filter member 393. With such a configuration, when the dust filter 390 mounted in the filter receiving space 360 is removed from the filter receiving space 360 by sliding forward, the rear rib 397 may prevent the dust filtered by the filter member 393 from moving to the rear of the filter frame 391 and entering the heat dissipation duct 700.

The rear rib 397 may be provided in front of the rear wall 391b of the filter frame 391. Specifically, the rear rib 397 may be provided between the filter member 393 and the rear wall 391b. More specifically, the rear rib 397 may be provided between the reinforcing rib 391a and the rear wall 391b.

As described above, when the dust filter 390 is mounted in the filter receiving space 360, the rear wall 391b of the filter frame 391 and the barrier wall 374 of the top cover 300 may contact each other, thereby preventing the dust filtered by the filter member 393 from moving to the rear of the filter frame 391 and entering the heat dissipation duct 700. However, when the dust filter 390 is removed from the filter receiving space 360, the rear wall 391b and the barrier wall 374 may no longer be in contact. At this time, because the dust filter 390 is separated from the filter receiving space 360 in a state where the rear wall 391b is disposed spaced apart from the air inlet portion 350, the dust filtered by the filter member 393 may move between the rear wall 391b and the air inlet portion 350 and enter the heat dissipation duct 700.

According to the concept of the present disclosure, the rear rib 397 may have a greater height than the rear wall 391b of the filter frame 391. Specifically, with respect to the plane on which the filter member 393 is formed, a height H1 of the rear rib 397 may be greater than a height H2 of the rear wall 391b. In other words, when the dust filter 390 is mounted in the filter receiving space 360, the rear rib 397 and the rear wall 391b may each be provided to be spaced apart from the air inlet portion 350, and a distance between the rear rib 397 and the air inlet portion 350 may be formed to be shorter than a distance between the rear wall 391b and the air inlet portion 350. Accordingly, the rear rib 397 may prevent the dust filtered by the filter member 393 from moving between the rear wall 391b and the air inlet portion 350, thereby preventing the dust from entering the heat dissipation duct 700.

The rear rib 397 may extend in a direction parallel to the rear wall 391b of the filter frame 391. In other words, the rear rib 397 may extend in the left-to-right direction.

The rear rib 397 may be connected to each of the pair of movable rail portions 392. Specifically, the rear rib 397 may be connected to the pair of vertical movable rail portions 392b. That is, one end of the rear rib 397 may be connected to the vertical movable rail portion 392b on one side, and the other end of the rear rib 397 may be connected to the movable rail portion 392b on the other side.

As described above, each of the pair of movable rail portions 392 may be formed to protrude from one end and the other end of the filter frame 391. The pair of movable rail portions 392 may have not only a function of stably supporting the dust filter 390 but also a function of preventing the dust filtered by the filter member 393 from moving to a left or right side of the filter frame 391 and entering the heat dissipation duct 700.

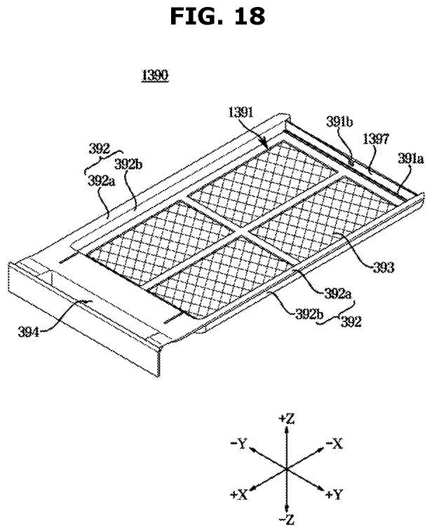

With respect to the plane on which the filter member 393 is formed, the rear rib 397 may have a lower height than the pair of movable rail portions 392. However, the present disclosure is not limited thereto, and the rear rib 397 may have the same height as the pair of movable rail portions 392 (see FIG. 18). This will be discussed in more detail later.

The rear rib 397 may have a first extension portion 397a, a second extension portion 397b, and a stepped portion 397c.

The first extension portion 397a may extend from the vertical movable rail portion 392b on one side, and the second extension portion 397b may extend from the vertical movable rail portion 392b on the other side. With respect to the plane on which the filter member 393 is formed, the first extension portion 397a and the second extension portion 397b may have the same height. Further, with respect to the plane on which the filter member 393 is formed, the first extension portion 397a and the second extension portion 397b may extend in the same direction as each other.

The stepped portion 397c may have a lower height than the first extension portion 397a or the second extension portion 397b with respect to the plane on which the filter member 393 is formed. The stepped portion 397c may be provided between the first extension portion 397a and the second extension portion 397b. With such a configuration, the stepped portion 397c may form a groove portion 397d together with the first extension portion 397a and the second extension portion 397b.

The groove portion 397d may be formed in a position corresponding to the position of the grille reinforcing rib 352 when the dust filter 390 is mounted in the filter receiving space 360. Such a configuration may prevent the grille reinforcing rib 352 from blocked entry of the dust filter 390 when the dust filter 390 is mounted in the filter receiving space 360.

As described above, the grille reinforcing rib 352 may extend along the central portion of each of the plurality of grilles 351. Correspondingly, the groove portion 397d may be formed by being recessed at a central portion of the rear rib 397. In other words, the stepped portion 397c may be provided in the central portion of the rear rib 397.

When the dust filter 390 is mounted in the filter receiving space 360, the grille reinforcing rib 352 may be provided on an upper side of the stepped portion 397c, and the plurality of grilles 351 may be provided on an upper side of the first extension portion 397a and the second extension portion 397b. When the dust filter 390 is mounted in the filter receiving space 360, a distance W1 by which the first extension portion 397a is spaced apart from the plurality of grilles 351 may be longer than a distance W2 by which the stepped portion 397c is spaced apart from the grille reinforcing rib 352, based on the up-and-down direction.

With such a configuration, when the dust filter 390 is slidably mounted in the filter receiving space 360, the grille reinforcing rib 352 and the stepped portion 397c may be in contact, but the first extension portion 397a and the second extension portion 397c may not be in contact with the plurality of grilles 351. In other words, when the dust filter 390 is mounted in the filter receiving space 360, the grille reinforcing rib 352 and the stepped portion 397c may guide the dust filter 390 such that the dust filter 390 is stably inserted into the filter receiving space 360. Accordingly, when the dust filter 390 is mounted in the filter receiving space 360, noise that may be generated by the first extension portion 397a or the second extension portion 397b contacting the plurality of grilles 351 may be reduced, and damage to the dust filter 390 or the top cover 300 may be prevented.

FIG. 18 is a perspective view illustrating a dust filter according to an embodiment.

In the following, a dust filter 1390 according to an embodiment of the present disclosure will be described with reference to FIG. 18. In describing the dust filter 1390, the same reference numerals are assigned to configurations substantially the same as those shown in FIGS. 1 to 17, and detailed description thereof may be omitted.

Referring to FIG. 18, a filter frame 1391 of the dust filter 1390 may include a rear rib 1397 provided at a rear end portion of the filter frame 1391. The rear rib 1397 shown in FIG. 18, unlike the rear rib 397 shown in FIGS. 10 to 17, may have the same height as the pair of movable rail portions 392. In other words, the rear ribs 397 and 1397 according to the present disclosure may have a height equal to or lower than the pair of movable rail portions 392 with respect to the plane on which the filter member 393 is formed.

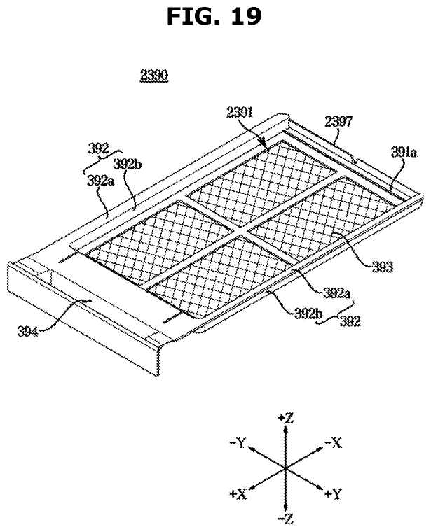

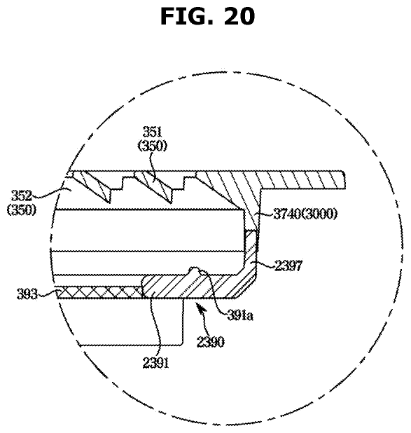

FIG. 19 is a perspective view illustrating a dust filter according to an embodiment. FIG. 20 is an enlarged view illustrating a state in which a rear rib of a filter frame and a barrier wall of a top cover contact each other when the dust filter shown in FIG. 19 is mounted to the top cover.

In the following, a dust filter 2390 according to an embodiment of the present disclosure will be described with reference to FIGS. 19 and 20. In describing the dust filter 2390, the same reference numerals are assigned to configurations substantially the same as those shown in FIGS. 1 to 17, and further description thereof may be omitted.

Referring to FIGS. 19 and 20, a filter frame 2391 of the dust filter 2390 may include a rear rib 2397 provided at a rear end portion of the filter frame 2391. The rear rib 2397 may be formed at a rearmost end of the plane on which the filter member 393 is formed. In other words, the rear rib 2397 shown in FIGS. 19 and 20 may simultaneously perform the functions of the rear wall 391b and the rear rib 397 of the filter frame 391 shown in FIGS. 1 to 17.

Specifically, when the dust filter 2390 is removed from the filter receiving space 360, the rear rib 2397 may prevent the dust filtered by the filter member 393 from traveling to the rear of the filter frame 2391 and entering the heat dissipation duct 700. To this end, with respect to the plane on which the filter member 393 is formed, the rear rib 2397 shown in FIGS. 19 and 20 may have a greater height than the rear wall 391b of the filter frame 391 shown in FIGS. 1 to 17.

Furthermore, when the dust filter 2390 is mounted in the filter receiving space 360, the rear rib 2397 of the filter frame 2391 and a barrier wall 3740 of a top cover 3000 may contact each other, thereby preventing the dust filtered by the filter member 393 from traveling to the rear of the filter frame 2391 and entering the heat dissipation duct 700. In this case, a length by which the barrier wall 3740 of the top cover 3000 shown in FIG. 20 extends may be shorter than a length by which the barrier wall 374 of the top cover 300 shown in FIG. 15 extends.

The refrigerator 1 according to an embodiment may include the main body 100, the thermoelectric element 510 provided on the upper wall 110 of the main body 100 and having the heat generating portion 511 and the heat absorbing portion 512, the heat sink 520 in contact with the heat generating portion 511, the heat dissipation fan 600 configured to generate an air flow, the heat dissipation duct 700 including the outside air inlet 741 and the outside air outlets 751 and 752 and configured to be coupled to the upper wall 110 of the main body 100 to guide air flowing by the heat dissipation fan 600 to exchange heat with the heat sink 520, the top cover 300 or 3000 including the filter receiving space 360 provided in a position corresponding to the outside air inlet 741, and the dust filter 390, 1390, or 2390 detachably mountable in the filter receiving space 360. The dust filter 390, 1390, or 2390 may include the filter member 393 configured to filter out dust from the air and the filter frame 391, 1391, or 2391 configured to support the filter member 393. The filter frame 391, 1391, or 2391 may include the rear rib 397, 1397, or 2397 protruding upwardly from the filter frame 391, 1391, or 2391 to prevent the dust filtered by the filter member 393 from entering the heat dissipation duct 700 when the dust filter 390, 1390, or 2390 is separated from the filter receiving space 360.

The dust filter 390, 1390, or 2390 may be mounted in the filter receiving space 360 by sliding rearward, and may be removed from the filter receiving space 360 by sliding forward.

The top cover 300 or 3000 may include the pair of fixed rail portions 371 provided on one side and the other side of the filter receiving space 360. The filter frame 391, 1391, or 2391 may include the pair of movable rail portions 392 formed on one side and the other side of the filter frame 391, 1391, or 2391 to be slidably supported by the pair of fixed rail portions 371.

The rear rib 397, 1397, or 2397 may be provided at a rear of the filter member 393.

The top cover 300 may further include the barrier wall 374 provided at a rear side of the filter receiving space 360. The filter frame 391 or 1391 may further include a rear wall 391b provided at a rear end portion of the filter frame 391 or 1391, the rear wall 391b contacting the barrier wall 374 to prevent dust filtered by the dust filter 390 or 1390 from entering the heat dissipation duct 700 when the dust filter 390 or 1390 is mounted in the filter receiving space 360. The rear rib 397 or 1397 may be provided between the filter member 393 and the rear wall 391b.

With respect to a plane on which the filter member 393 is formed, the rear rib 397 or 1397 may have a greater height than the rear wall 391b.

The rear rib 397 or 1397 may extend in a direction parallel to the rear wall 391b.

The filter frame 391 or 1391 may further include the reinforcing rib 391a provided at the rear end portion of the filter frame 391 or 1391 to prevent the dust filter 390 or 1390 from being deflected. The rear rib 397 or 1397 may be provided between the reinforcing rib 391a and the rear wall 391b.

The rear rib 397, 1397, or 2397 may be connected to each of the pair of movable rail portions 392.

Each of the pair of movable rail portions 392 may be formed to protrude from one end and the other end of the filter frame 391, 1391, or 2391. With respect to a plane on which the filter member 393 is formed, the rear rib 397, 1397, or 2397 may have a height equal to or lower than the pair of movable rail portions 392.

The top cover 300 or 3000 may further include the air inlet portion 350 provided on an upper side of the filter receiving space 360. When the dust filter 390, 1390, or 2390 is mounted in the filter receiving space 360, the rear rib 397, 1397, or 2397 may be arranged to be spaced apart from the air inlet portion 350.

The air inlet portion 350 may include the plurality of grilles 351 arranged to be spaced apart from each other, and the grille reinforcing rib 352 extending in a direction intersecting each of the plurality of grilles 351 and protruding downwardly from the plurality of grilles 351. The rear rib 397, 1397, or 2397 may include the groove portion 397d formed in a position corresponding to a position of the grille reinforcing rib 352 when the dust filter 390, 1390, or 2390 is mounted in the filter receiving space 360.

The groove portion 397d may be formed by being recessed at a central portion of the rear rib 397, 1397, or 2397.

The rear rib 397, 1397, or 2397 may further include the first and second extension portions 397a and 397b extending in the same direction as each other and having the same height relative to a plane on which the filter member 393 is formed, and the stepped portion 397c having a lower height than the first extension portion 397a with respect to the plane on which the filter member 393 is formed, the stepped portion 397c being provided between the first extension portion 397a and the second extension portion 397b to form the groove portion 397d together with the first extension portion 397a and the second extension portion 397b. When the dust filter 390, 1390, or 2390 is mounted in the filter receiving space 360, a distance by which the first extension portion 397a is spaced apart from the plurality of grilles 351 based on an up-and-down direction may be longer than a distance by which the stepped portion 397c is spaced apart from the grille reinforcing rib 352.

The top cover 3000 may further include the barrier wall 3740 provided at a rear side of the filter receiving space 360. The rear rib 2397 may be configured to contact the barrier wall 3740 to prevent the dust filtered by the dust filter 2390 from entering the heat dissipation duct 700 when the dust filter 2390 is mounted in the filter receiving space 360.

The refrigerator 1 according to an embodiment may include the main body 100, the thermoelectric element 510 provided on the upper wall 110 of the main body 100 and having the heat generating portion 511 and the heat absorbing portion 512, the heat sink 520 configured to contact the heat generating portion 511, the heat dissipation fan 600 configured to cause air to flow, the heat dissipation duct 700 having the outside air inlet 741 and the outside air outlets 751 and 752 and configured to be coupled to the upper wall 110 of the main body 100 to guide the air flowing by the heat dissipation fan 600 to exchange heat with the heat sink 520, the top cover 300 or 3000 including the filter receiving space 360 provided in a position corresponding to the outside air inlet 741 and the air inlet portion 350 provided on one side of the filter receiving space 360, and the dust filter 390, 1390, or 2390 configured to be detachably mounted in the filter receiving space 360 of the top cover 300 or 3000. The dust filter 390, 1390, or 2390 may include the filter member 393 configured to filter out dust from the air and the filter frame 391, 1391, or 2391 configured to support the filter member 393. The filter frame 391, 1391, or 2391 may include the rear rib 397, 1397, or 2397 protruding toward the air inlet portion 350 from a rear end portion of the filter frame 391, 1391, or 2391 when the dust filter 390, 1390, or 2390 is mounted in the filter receiving space 360.

When the dust filter 390, 1390, or 2390 is mounted in the filter receiving space 360, the rear rib 397, 1397, or 2397 may protrude toward a rear end portion of the air inlet portion 350.

When the dust filter 390, 1390, or 2390 is mounted in the filter receiving space 360, the rear rib 397, 1397, or 2397 may be provided to be spaced apart from the air inlet portion 350.

The air inlet portion 350 may include the plurality of grilles 351 provided to be spaced apart from each other, and the grille reinforcing rib 352 protruding downwardly from the plurality of grilles 351. The rear rib 397, 1397, or 2397 may include the groove portion 397d formed in a position corresponding to a position of the grille reinforcing rib 352 when the dust filter 390, 1390, or 2390 is mounted in the filter receiving space 360.

The groove portion 397d may be formed by being recessed at a central portion of the rear rib 397, 1397, or 2397.

According to the concept of the present disclosure, the dust filter may be detachably mounted to the top cover of the refrigerator in a sliding manner. When the dust filter is mounted to the top cover, the dust filter may filter out dust from the air drawn into the interior of the heat dissipation duct.

According to the concept of the present disclosure, the rear rib may be provided at the rear end portion of the filter frame of the dust filter. When the dust filter is removed from the top cover, the rear rib may prevent the dust filtered by the dust filter from entering the heat dissipation duct.

The effects to be obtained from the present disclosure are not limited to the effects mentioned above, and other unmentioned effects may be clearly understood by those of ordinary skill in the art to which the present disclosure pertains from the description below.

While the present disclosure has been particularly described with reference to exemplary embodiments, it should be understood by those of skilled in the art that various changes in form and details may be made without departing from the spirit and scope of the present disclosure.

1. A refrigerator, comprising:
a main body;
a thermoelectric element, to be provided on an upper wall of the main body, including a heat generating portion and a heat absorbing portion;
a heat sink in contact with the heat generating portion;
a heat dissipation fan configured to generate air flow;
a heat dissipation duct, including an outside air inlet and an outside air outlet, configured to be coupled to the upper wall of the main body such that while the heat dissipation duct is coupled to the upper wall of the main body, air guided by the heat dissipation fan flows through the heat dissipation duct to exchange heat with the heat sink;
a top cover, including a filter receiving space, to be provided at a position corresponding to a position of the outside air inlet; and
a dust filter coupleable in and decoupleable from the filter receiving space,
wherein the dust filter comprises:
a filter member configured to filter dust from the air, and
a filter frame configured to support the filter member,
wherein the filter frame comprises a rear rib protruding upwardly from the filter frame to prevent the dust filtered by the filter member from entering the heat dissipation duct based on the dust filter being decoupled from the filter receiving space.

2. The refrigerator of claim 1, wherein the dust filter is coupled in the filter receiving space based on the dust filter being slid along a rear direction of the refrigerator, and the dust filter is decoupled from the filter receiving space based on the dust filter being slid along a forward direction of the refrigerator.

3. The refrigerator of claim 2, wherein
the top cover comprises a pair of fixed rail portions provided on one side of the filter receiving space and another side of the filter receiving space, and
the filter frame comprises a pair of movable rail portions provided on one side of the filter frame and another side of the filter frame to be slidable along and supported by the pair of fixed rail portions.

4. The refrigerator of claim 1, wherein the rear rib is provided at a rear of the filter member.

5. The refrigerator of claim 4, wherein
the top cover further comprises a barrier wall provided at a rear side of the filter receiving space,
the filter frame further comprises a rear wall provided at a rear end portion of the filter frame, the rear wall contacting the barrier wall to prevent dust filtered by the dust filter from entering the heat dissipation duct based on the dust filter being coupled in the filter receiving space, and
the rear rib is provided between the filter member and the rear wall.

6. The refrigerator of claim 5, wherein, with respect to a plane on which the filter member is formed, the rear rib has a greater height than the rear wall.

7. The refrigerator of claim 5, wherein the rear rib extends in a direction parallel to the rear wall.

8. The refrigerator of claim 5, wherein
the filter frame further comprises a reinforcing rib provided at the rear end portion of the filter frame to prevent the dust filter from being deflected, and
the rear rib is provided between the reinforcing rib and the rear wall.

9. The refrigerator of claim 3, wherein the rear rib is connected to each of the pair of movable rail portions.

10. The refrigerator of claim 3, wherein
the pair of movable rail portions is formed to protrude from one end of the filter frame and the other end of the filter frame, and
with respect to a plane on which the filter member is formed, the rear rib has a height equal to or lower than the pair of movable rail portions.

11. The refrigerator of claim 1, wherein
the top cover further comprises an air inlet portion provided on an upper side of the filter receiving space, and
based on the dust filter being coupled in the filter receiving space, the rear rib is arranged to be spaced apart from the air inlet portion.

12. The refrigerator of claim 11, wherein
the air inlet portion comprises:
a plurality of grilles arranged to be spaced apart from each other; and
a grille reinforcing rib extending in a direction intersecting each of the plurality of grilles and protruding downwardly from the plurality of grilles, and
the rear rib comprises:
a groove portion formed in a position corresponding to a position of the grille reinforcing rib based on the dust filter being coupled in the filter receiving space.

13. The refrigerator of claim 12, wherein the groove portion is formed by being recessed at a central portion of the rear rib.

14. The refrigerator of claim 12, wherein
the rear rib further comprises:
a first extension portion and a second extension portion extending along a direction that is same as each other and having a height that is same relative to a plane on which the filter member is formed; and
a stepped portion having a lower height than the first extension portion with respect to the plane on which the filter member is formed, the stepped portion being provided between the first extension portion and the second extension portion to form the groove portion together with the first extension portion and the second extension portion, and
based on the dust filter is coupled in the filter receiving space, a distance by which the first extension portion is spaced apart from the plurality of grilles along an up-and-down direction is longer than a distance by which the stepped portion is spaced apart from the grille reinforcing rib.

15. The refrigerator of claim 1, wherein
the top cover further comprises a barrier wall provided at a rear side of the filter receiving space, and
the rear rib is configured to contact the barrier wall to prevent the dust filtered by the dust filter from entering the heat dissipation duct based on the dust filter being coupled in the filter receiving space.
